(19) United States
(12) Patent Application Publication
(10) Pub. No.: US 2021/0241357 A1
(43) Pub. Date: Aug. 5, 2021

(54) CUSTOMIZABLE AND EXTENSIBLE MANAGED INTEGRATION PLATFORM

(71) Applicant: Knect Software Services LLC, Seattle, WA (US)

(72) Inventor: Jimmy Fursman, Seattle, WA (US)

(21) Appl. No.: 17/163,181

(22) Filed: Jan. 29, 2021

Related U.S. Application Data
(60) Provisional application No. 62/967,952, filed on Jan. 30, 2020.

(51) Int. Cl. G06Q 30/06; G06F 9/54; G06Q 10/08; G06F 16/25

(52) U.S. Cl. CPC G06Q 30/0635; G06F 9/542; G06F 16/252; G06F 16/258; G06Q 10/087

(57) ABSTRACT

Systems and methods are described herein for an integration platform that uses data connectors to translate data between two different systems, such as between merchant and backend systems. In one example, an integration platform may obtain a request, including a object, from a first application using a first transmission method. The integration platform may convert the data object from a first application format to a platform specific format using a first connector to generate a first modified data object, with the first connector specifying the first data transmission method. The integration platform may additionally convert the first modified data object from the platform specific format to a backend system format using a second connector to generate a second modified data object, where the second modified data object is consumable by the backend system to perform an action in response to the request.

### CROSS-REFERENCE TO RELATED APPLICATIONS

This application claims the benefit of U.S. Provisional Patent Application No. 62/967,952, filed Jan. 30, 2020, the disclosure of which is incorporated herein by reference in its entirety.

### BACKGROUND

In various sectors, different business applications need to talk to one another, even though they typically use data in different formats, accessed via different ways and for different purposes. This is particularly relevant in the online sales space, where various third party websites and merchant systems, such as Shopify, Amazon, etc., offer goods for sale, where different backend systems, such as custom relation manager (CRM) systems, enterprise resource planning (ERP) systems, warehouse management system, etc., are utilized by the various sellers to fulfil orders, manage inventory, warehousing, etc. Typically, these application have used software integrations to talk to one another. These software integrations are usually bespoke and purpose-built and specific to each individual application that is used—both the merchant system side and on the backend system side. Full standardization in this area is not common because it is found to be too restrictive for the needs of an individual business and its respective business strategy. Without a tool or platform that allows or encourages re-use of software that solves the common needs of businesses integrating 3rd party platforms, the de facto result is that software integrations are usually bespoke and purpose-built, with the work to build and maintain them redundant between businesses in the marketplace.

### BRIEF DESCRIPTION OF THE DRAWINGS

Various techniques will be described with reference to the drawings, in which:

FIG. 1 illustrates an environment in which the described techniques may be practiced using an integration platform, in accordance with at least one embodiment;

FIG. 2 illustrates an example integration platform, in accordance with at least one embodiment;

FIG. 3 illustrates an example diagram of a data interface, as may be used by the integration platform of FIGS. 1 and 2 in accordance with at least one embodiment;

FIG. 4 illustrates an example of a data point, as may be used by the integration platform of FIGS. 1 and 2 in accordance with at least one embodiment;

FIG. 5 illustrates an example process for importing an order from a merchant system by an integration platform, in accordance with at least one embodiment;

FIG. 6 illustrates an example process for exporting an order to a backend system by an integration platform, in accordance with at least one embodiment;

FIG. 7 illustrates an example process for importing a fulfilment record from a backend system by an integration platform, in accordance with at least one embodiment;

FIG. 8 illustrates an example process for exporting a fulfilment record to a merchant system by an integration platform, in accordance with at least one embodiment;

FIG. 9 illustrates an example process for processing payment by a backend system in coordination with an integration platform, in accordance with at least one embodiment;

FIG. 10 illustrates an example process for converting data received from a merchant system to be usable by a backend system, in accordance with at least one embodiment; and

FIG. 11 illustrates an example process for converting data received from a backend system to be usable by a merchant system, in accordance with at least one embodiment.

### DETAILED DESCRIPTION

The present disclosure provides various examples of an on-demand, customizable, extensible, managed integration platform, which is referred to in some embodiments as “Knect.” In various embodiments, Knect is a platform built from modular software components (collectively known as ‘Knect’) that allow separate 3rd party business applications to transmit data to one another. Commonly known as software integrations, these connections between separate business systems are usually bespoke and purpose-built. In various examples, Knect may increase efficiency, lowers cost, and/or reduce time to market by standardizing the integration methodology and data formats between various 3rd party business applications, including publicity available applications. In various embodiments, Knect addresses one or more challenges presented by custom solutions through a software architecture and series of software components meant to standardize common actions & processes, communicate directly with publicly available 3rd party business applications, and allow for custom modification, normalization, and/or reorganization of transmitted data to meet the specific needs of a single business.

Various implementations of Knect can handle an integration between an e-Commerce website or merchant system and a backend system, such as an ERP application. The integration can be transport, order, and customer data to the ERP system, which can subsequently handle invoicing and the creation of records regarding the fulfillment of the order. Fulfillment information can then be communicated back to the e-Commerce website for the completion of the order, email notification to the customer, and logging the completed order in the customer's order history on the website.

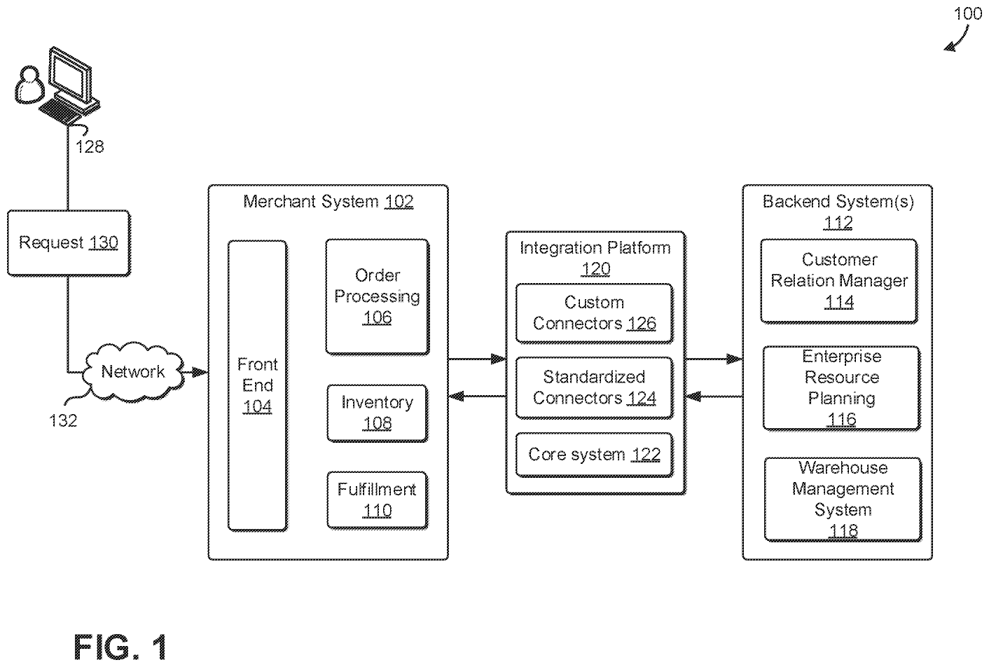

FIG. 1 illustrates an environment 100 in which the described techniques may be practiced using an integration platform 120. As illustrated in FIG. 1, a user 128 may send requests 130 to a merchant system 102 over a network 132. The user 128 may include any computing device, such as may access a merchant system 102, such as provided via one or more web interfaces, over a network 132, such as the internet. The request 130 may include any of a variety of types and formats of information. In one specific example, the request 130 may include an order or purchase of goods or services, from or through merchant system 102. In this example, merchant system 102 may provide an e-commerce website or other system providing a user interface for browsing, comparing, and purchasing goods and services, such as may be provided by one or more sellers associated with the merchant system 102.

In some examples, the merchant system 102 be a commonly used shopping platform or e-commerce website, such as Shopify, Amazon, Ebay, etc., and may include any of a number of computing and network resources for interacting with a user 128 and other systems, such as integration platform 120 and backend system(s) 112, as will be described in greater detail below. Merchant system 102 may be hosted by hardware computing resources, such as physical servers, virtual computing resources, such as virtual machines, software containers, etc., provided by a cloud services providers, or a combination thereof. Merchant system 102, in some aspects, may include various features for enabling a user 128 to interact with and purchase goods and services form one or more different sellers. For example, the merchant system 102 may include a front end 104, which may provide a user interface, such as a graphical user interface, displaying goods for purchase to a user 128 via web-based systems. The merchant system 102 may also include an order processing component 106, which may obtain user and order information from user 128 through front end 104 to effectuate consuming of goods and services. In some aspects, order processing component 106 may interact with integration platform 120 and/or back end system(s) 112 to place and fulfil orders with an underlying seller's backend system(s) 112.

The merchant system 102 may also include an inventory process or component 108 that tracks inventory available for listing on the merchant system 102. In some aspects, inventory component 108 may be updated at various times or periodically by one or more of integration platform 120 and/or backend system(s) 112, as will be described in greater detail below. In some cases, the inventory component may indicate what inventory and how much of that inventory is available through the merchant system. In yet some cases, the inventory component may further provide details of specific item in the inventory. In some aspects, the integration platform 120 may interface with one or more backend systems 112 to provide updates to inventory items, inventory levels (numbers of certain items that are currently available), and even provide updates to specific information regarding individual inventory items, referred to generally as product attributes. This information may include one or more of weight, dimensions, country of origin, source materials or ingredients, digital photographs, pricing, descriptions, features, specifications, alternate names, UPC codes, and translations relating to individual inventory items or products. With this capability, Knect 120 can automate the population of entire product catalogs into an e-Commerce website or merchant system 102 from other backend systems 112, such as a Product Information Manager, Digital Asset Manager, ERP, database or even a series of spreadsheets.

In some aspects, the merchant system 102 may also include a fulfillment process or component 110, which may manage fulfillment of orders placed through the merchant system 102. In some aspects, the fulfillment component 110 may interact with one or more of integration platform 120 and/or backend system(s) 112, as will be described in greater detail below, to coordinate shipment and notify the user 128 of the same.

The backend system(s) 112 may include any of number of seller provided and/or custom applications and programs hosted by the seller or other entity to facilitate order processing, fulfillment and payment for various goods and services provided by the seller. Back end system(s) 112 may collectively or individually be hosted by hardware computing resources, such as physical servers, virtual computing resources, such as virtual machines, software containers, etc., provided by a cloud services providers, or a combination thereof. In the example illustrated, the backend systems 112 may include a custom relation manager (CRM) 114, an enterprise resource planning (ERP) system 116, and/or a warehouse management system 118, as are generally known in the art. For example, CRM 114 may manage interactions with past, current, and potential customers, such as by storing interactions with customers across various channels, to help improve customer relations and increase sales. ERP system 116 may provide an overview of core business processes using one or more databases, such as maintained by a database management system. ERP system 116 may track business resources, such as raw materials, production capacity, etc., and the status of business commitments: orders, purchase orders, and payroll. ERP system 116 may include a number of different applications that interface together to manage orders and customer information for a given seller. Warehouse management system 118 may manage and track inventory and shipment information for orders. It should be appreciated that these systems or processes are only given by way of example, and that various other systems may be used and implemented by a seller or other party to carry out various functions relating to providing goods and services through merchant system 102, which may in turn interact with the described integration platform 120.

As described herein, an integration platform 120 may be provided that standardizes interaction between one or more merchant systems 102 and one or more backend systems 112 using a number of data interfaces. Integration platform 120 may be hosted by hardware computing resources, such as physical servers, virtual computing resources, such as virtual machines, software containers, etc., provided by a cloud services providers, or a combination thereof. An example integration platform 120 may include a core system 122, standardized connectors or data interfaces 124, and custom connectors or data interfaces 126. In some cases individual data interfaces may be referred to herein as Knect Components or ‘Knectors.’ Core system 122 may be a collection of software components that are common between different implementations of the integration platform 120. Core system 122 may include one or more of: all basic input/output functions, always-on serverless cloud hosting, data transmission scheduling, real-time triggered data transmission events, user management, access control management, system configuration, event notifications, event logging, database connections, a graphical user interface, and other functions or components, as will be described in greater detail below.

Standardized data interfaces 124 may include a library of available standard interfaces to common 3rd party business applications. Just as every business uses a different mix of applications, different implementations of integration platform 120 in some examples could use a different mix of data interfaces. Individual data interfaces or connectors may define the data transmission method and format to interface with different applications, as will be described in greater detail below.

In various embodiments, a custom connector layer or Knect Customization layer 126 can comprise a collection of software components that are particular to an individual business and its implementation of the integration platform. By extending functionality found in the core system 122 or the standard data interfaces 124, the Knect Customization layer 126 in some examples is able to efficiently offer bespoke capabilities to any business. In addition to writing custom software that extends out-of-the-box capabilities, writing fully custom modules that interact with purpose-built software or data models is also possible in various embodiments. Businesses can have different needs in tracking or transmitting certain data around their sales operations—taxes, discounts, user stats, etc. The Knect Customization layer 126 in various examples allows for each business to efficiently reach beyond the restrictions of a fully standardized platform without the cost and maintenance of a fully bespoke platform.

In accordance with various embodiments, integration platform 120 can include 3 different layers: the core system 122, standardized connectors layer 124, and the custom connectors layer 126. Each layer of the platform can extend the capabilities of the layer beneath it. This architecture can allow for software component reuse between common functions and business requirements while simultaneously allowing for efficient & low-cost customization.

Using the standardized and custom connectors from layers 124 and 126, the integration platform 120 is able to import data from the merchant system 102, translate that information into a format usable and accessible by a backend system 122, and send that information to the relevant backend system 112. In addition, the integration platform is able to import data from a backend system 112, translate it into a format usable and accessible by the merchant system 102, and send that transformed information to the merchant system 102. Using these processes, the integration platform 120 can expedite and extend functionality between the merchant system 102 and back end systems 112, to enable order processing, fulfillment processing, inventory updating, shipment and payment processes between the various systems in seamless and efficient manner.

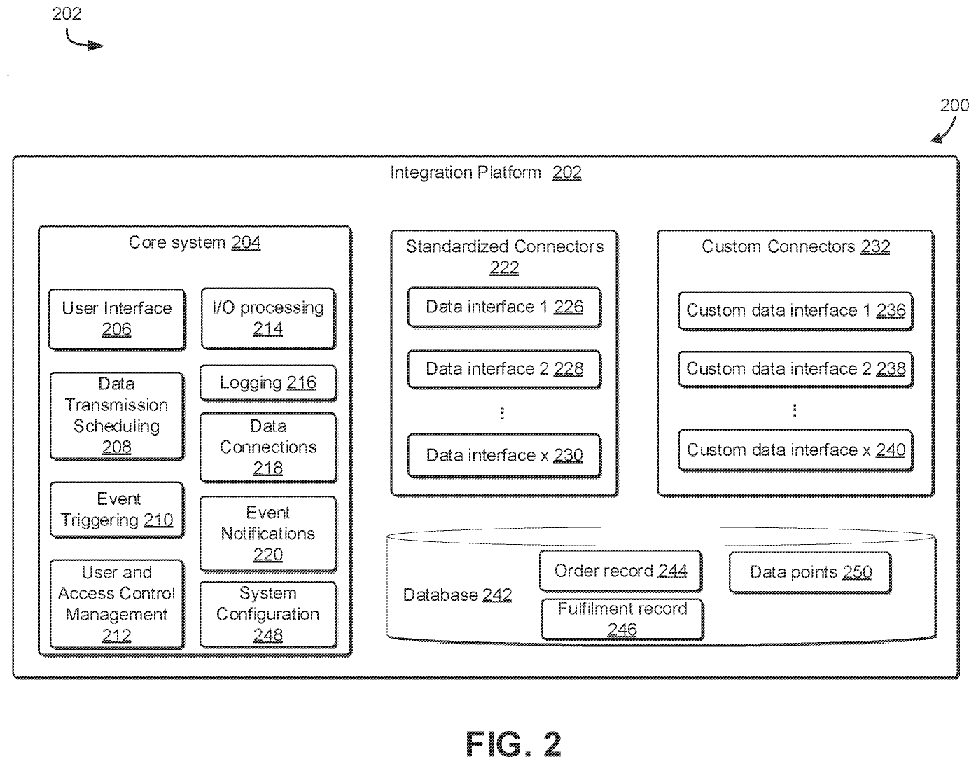

FIG. 2 illustrates a more detailed example of an integration platform 202, which may include one or more aspects of integration platform 120 described above in reference to FIG. 1. The Knect Core, or core system 204 of integration platform 202, in some embodiments, may include a graphical user interface 206, a data transmission scheduling component 208, an event triggering component 210, a user and access control management component or process 212, input/output (I/O) processing 214, logging component 216, data connections component 218, an event notifications component 220, and a system configuration component 248. One or more of these components may be processes executed by computing resources of the integration platform 202, including physical, virtual, or a combination of different types of resources.

Graphical user interface 206 may provide an interface for users to interact with and configure various processes performed by integration platform 202. These processes may include determining in what circumstances to use certain connectors, such as including event triggers and scheduling, provided by event triggering 210 and scheduling 208, customizing or configuring connectors, configuring notification via event notifications 220, modifying or configuring access control via component 212, configuring certain data connections 218 (e.g., data transmission methods or how a certain process of connector obtains and delivers data), and other processes.

Data transmission scheduling component 208 may store configuration parameters for scheduling the performance of certain processes. In some cases, one or more processes executed by integration platform 202 may be scheduled processes, such as when to retrieve certain data from merchant system 102, when to export certain data to a backend system 112, or vice versa. In some cases, one or more of processes 500, 600, 700, 800, 900, 1000, and/or 1100 described below may be initiated according to schedule. In these cases, scheduling component 208 may maintain some type of identification of a process to initiate and a schedule by which that process is initiated. In some cases the schedule may be based on a standard time (e.g., time of day), such that a process is initiated every 10 minutes, every hour, every 2 hours, every day, etc., or relative to a time, such as 10 minutes after every hour, or a certain time period after another event occurs. In yet some cases, scheduling component 208 may interact with event triggering component 210 to initiate certain processes or other actions taken by the integration platform 202.

The transmission event triggering component 210 may store triggering events associated with certain actions or process to be taken by the integration platform 202. In some cases, triggering events may include receiving a certain indication from merchant system 102 or backend system 112, such as receiving an order or a response indicating that an order has been fulfilled. In other cases, triggering events may include determining that a certain status of an order or ticket is of a certain value. For example, upon fulfilment of an order, the integration platform 202 may set a status of the order to fulfilled. Upon detecting that the order status is set to fulfilled, that may trigger the integration platform to transmit a message to merchant system 102 to notify a user that an order has been fulfilled/shipped. Various other examples of triggering events will be described throughout this disclosure. However, it should be appreciated that a trigger event may be of a huge variety of events, such as a backend system 112, merchant 102, or seller may deem useful.

User and access control management component or process 212 may maintain and store various information relating to users or customers interacting with merchant system 102 and/or roles, permissions, and other access restrictions for those users with respect to different aspects of the configuring the integration platform 202. Input/output (I/O) processing 214 may interact with the user interface 206 to convey data and messaging to users of the integration platform 202. Logging component 216 may collect and facilitate storing logs of different events and actions taken with and by the integration platform, such as to resolve errors with orders, the system, etc.

Data connections component 218 may store and enable configuration of different data connections to be used by various connectors utilized by the integration platform 202 to obtain, transmit, and store data, including through programming APIs, static file consumption, or direct database connections.

Event notifications component 220 may store and manage what notifications are transmitted based on certain events occurring relating to the integration platform 202. Notifications may be sent to merchant system 102, backend systems 112, or other end points. In some cases, the notifications may be internal, and may be used to trigger other actions or processes to be initiated.

System configuration component 248 may store and manage configuration parameters for the integration platform 202. In some cases, system configuration component 248 may enable a user to configure various parameters of a connector.

The integration platform 202 may also include standardized connectors 222 and custom connectors 232. The standardized connectors 222 may include any number of individual data interfaces 2126-230 (also referred to herein as connectors or Knectors). Standardized connectors 222 may include a library of available standard data interfaces 226-230 to common publicly available 3rd party business applications. Just as every business uses a different mix of applications, different implementations of the integration platform in some examples could use a different mix of data interfaces. Data interfaces can define the data transmission method and format to interface with every application. Business applications can support import/export of data through programming APIs, static file consumption, or direct database connections. Each 3rd party business application can also define a data structure by which it is able to execute data transmission and programmatic actions. The combination of data transmission method and data format can be unique to each 3rd party business application and therefore, in some examples, they each may utilize a separate Knector or data interface that is standard for that business application.

For instance, Shopify, an e-commerce platform, can offer data transmission via 2 API types (REST & GraphQL) and can define data structures for Orders, Customers, Products, Shipments, and Payments among others. A Knector for Shopify in various embodiments can be a standardized interface that allows for any applicable data or business process to move between Shopify and Knect. From there, the data or business process can move to another 3rd party business application, such as Customer Relation Manager (CRM), Enterprise Resource Planning (ERP), Warehouse Management System (WMS), or the like, using a separate standard or custom Knector.

In various embodiments, the custom connectors 232 include a collection of software components or data interfaces 236-240 that are particular to an individual business and its implementation of the integration platform 202. By extending functionality found in the core system 204 and standardized connectors 222, the custom connectors 232 in some examples are able to efficiently offer bespoke capabilities to any business. In addition to writing custom software that extends out-of-the-box capabilities, writing fully custom modules that interact with purpose-built software or data models is also possible in various embodiments, such as by defining new custom data interfaces or other data structures. Businesses can have different needs in tracking or transmitting certain data around their sales operations—taxes, discounts, user stats, etc.—the custom connectors 232 layer in various examples allows for each business to efficiently reach beyond the restrictions of a fully standardized platform without the cost and maintenance of a fully bespoke platform.

In some aspects, the integration platform may further include one or more databases 242, which may be hosted by the integration platform itself, or may be provided by a computing resource service provider, such as a cloud computing resource provider. Database 242 may include any type of data store, utilizing various forms of memory and so on. In some cases, one or more components of the core system 204 may utilize the database or data store 242 to store and access different data. In some aspects, the database 242 may store order records 244 and fulfillment records 246, among other records, which may be updated by the integration platform 202 upon different actions being completed and different event occurring. In some cases, the database 242 may store standardized data structures 250 representing common data points used in the various data interfaces 226-230. These data points may include common e-Commerce data points, such as Customers, Orders, Addresses, Payments, Shipments, Products, Inventory Items, Inventory Levels, and the like. In yet some cases, the data points 250 stored or managed by the integration platform 202 may also include taxes, discounts, user stats, and others, as will be described in greater detail below.

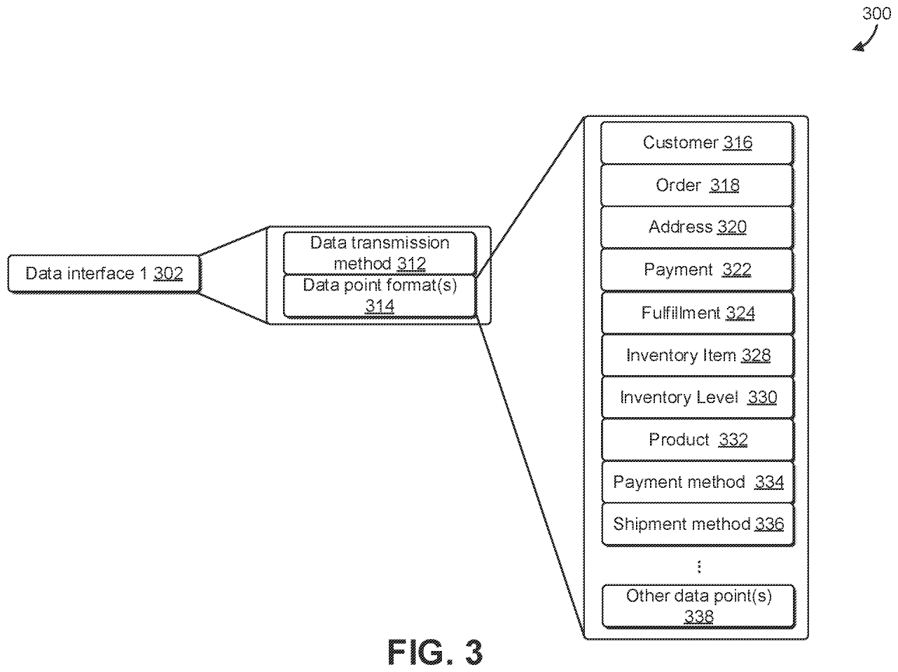

FIG. 3 illustrates an example diagram of a data interface, as may be used by the integration platform 120, 202, described above in reference to FIGS. 1 and 2. Data interface may represent a standard data interface or a custom interface, as described above in reference to FIG. 2. As illustrated, a data interface 302 may include two basic components: a data transmission method 312 which defines how data is obtained for the data interface 302, and one or more data point formats 314, which define how data is organized in a data structure to be usable or consumable by the relevant application. Example data points include customer 316, order 318, address 320, payment 322, fulfillment 324, inventory item 326, inventory level 328, product 332, payment method 334, shipment method 336, and other data points 338, such as may be defined for a custom data interface.

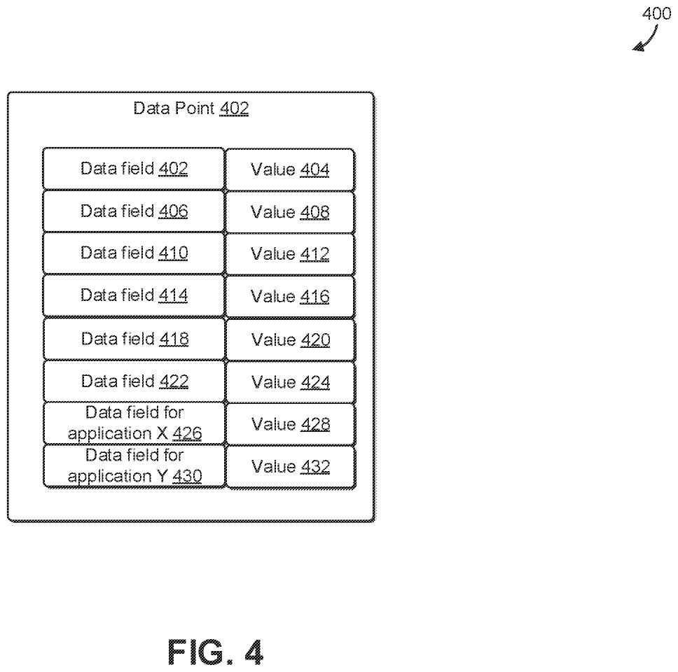

Each data point 316-338 may be defined by a data structure, such as data structure 402 illustrated in FIG. 4. Data point 402 may include any number of data fields, such as data fields 402, 406, 410, 414, 418, 422, 426, 428, and corresponding values 404, 408, 412, 416, 420, 424, 428, 432. Each data field may be determined for a different data point, and the corresponding value may have a specific format and/or default values associated with the data point if a value is not available. Examples of different data points, and corresponding field and values will be described in greater detail below.

Customer data points 316: Customer records can represent a single account or email address in use on the e-Commerce website. A customer may have many Orders. Customer records may originate on the website or the ERP system, depending on the use case.

Order data pints 318: Order records can represent a single transaction on the e-Commerce website and generally map 1:1 to a transaction in the ERP or CRM system(s). An Order can belong to one Customer and may have many Addresses, Payments, Order Items, Fulfillments, and the like. Orders 318 can be tracked sequentially and can be the base data point for integrations of this type. An Order 318 being available for import/export can serve as the catalyst for some or all remaining functions and in Knect.

Example Order Data Fields:
‘id’ int(10) unsigned NOT NULL AUTO_INCREMENT,
‘customer_id’ int(10) unsigned NOT NULL,
‘shipment_method’ varchar(255) COLLATE utf8mb4_unicode_ci DEFAULT NULL,
‘total_shipping’ decimal(8,2) NOT NULL DEFAULT ‘0.00’,
‘total_discount’ decimal(8,2) NOT NULL DEFAULT ‘0.00’,
‘total_tax’ decimal(8,2) NOT NULL DEFAULT ‘0.00’,
‘total_ price’ decimal(8,2) NOT NULL DEFAULT ‘0.00’,
‘coupon_code’ varchar(255) COLLATE utf8mb4 unicode_ci DEFAULT NULL,
‘export_status’ int(11) NOT NULL DEFAULT ‘0’,
‘created_at’ timestamp NULL DEFAULT NULL,
‘updated_at’ timestamp NULL DEFAULT NULL,

(*) In various embodiments, Knectors can add fields to hold the unique identifiers from 3rd Party Applications, which can allow for mapping of a single order between multiple systems using multiple identifiers.

Order Items (not illustrated): Order Item records can represent a line item on the Order transaction from the e-Commerce website, CRM, or ERP system. In various examples, all order items belong to one and only one Order. In some examples, Order Items can have an equivalent Fulfillment Item.

Example Order Item Data Fields:
‘id’ int(10) unsigned NOT NULL AUTO_INCREMENT,
‘order_id’ int(10) unsigned NOT NULL,
‘sku’ varchar(255) COLLATE utf8mb4_unicode_ci DEFAULT NULL,
‘product name’ varchar(255) COLLATE utf8mb4_unicode_ci NOT NULL,
‘price’ decimal(8,2) NOT NULL,
‘item_tax’ decimal(8,2) DEFAULT ‘0.00’,
‘discount’ decimal(8,2) NOT NULL,
‘qty’ int(11) NOT NULL,
‘fulfillment_status’ varchar(255) COLLATE utf8mb4_unicode_ci DEFAULT NULL,
‘product_img_url’ varchar(255) COLLATE utf8mb4_unicode_ci DEFAULT NULL,
‘created_at’ timestamp NULL DEFAULT NULL,
‘updated_at’ timestamp NULL DEFAULT NULL,

Address data point 320: Address records can represent the billing or shipping addresses associated with an Order 318. In various examples, all addresses belong to a single Order record 318. While some 3rd party business applications can associate default addresses or an address book with a Customer record 316, this can merely be for pre-population purposes in some examples and the end result can be that an Order 318 will have distinct billing and shipping addresses. In various embodiments, Address records 320 belong to an Order record 318 because Orders 318 can be the base data point for integrations of this type.

Example Address Data Fields:
‘id’ int(10) unsigned NOT NULL AUTO_INCREMENT,
‘order_id’ int(10) unsigned NOT NULL,
‘billing_or_shipping’ enum(‘billing’,‘shipping’) COLLATE utf8mb4_unicode_ci NOT NULL,
‘first_name’ varchar(255) COLLATE utf8mb4_unicode_ci NOT NULL,
‘last_name’ varchar(255) COLLATE utf8mb4_unicode_ci NOT NULL,
‘phone’ varchar(255) COLLATE utf8mb4_unicode_ci DEFAULT NULL,
‘address_1’ varchar(255) COLLATE utf8mb4_unicode_ci NOT NULL,
‘address_2’ varchar(255) COLLATE utf8mb4_unicode_ci DEFAULT NULL,
‘address_3’ varchar(255) COLLATE utf8mb4_unicode_ci DEFAULT NULL,
‘city’ varchar(255) COLLATE utf8mb4_unicode_ci NOT NULL,
‘state’ varchar(255) COLLATE utf8mb4_unicod_ci NOT NULL,
‘postal_code’ varchar(255) COLLATE utf8mb4_unicode_ci NOT NULL,
‘country’ varchar(255) COLLATE utf8mb4_unicode_ci DEFAULT NULL,
‘company’ varchar(255) COLLATE utf8mb4_unicode_ci DEFAULT NULL,
‘created_at’ timestamp NULL DEFAULT NULL,
‘updated_at’ timestamp NULL DEFAULT NULL,

(*) In various embodiments, Knectors can add fields to hold the unique identifiers from 3rd Party Applications, which can allow for mapping of a single order between multiple systems using multiple identifiers.

Payment data point 322: Payment records 322 can represent the method(s) and/or amount(s) of payments on the Order record 318, as entered on the e-Commerce website. Depending on the implementation of Knect, Payment records 322 may be exported with Orders 318 or may be held in Knect until an invoice is created in the ERP or other fulfillment or finance system. Once an invoice is available, payments can be exported to the next system and applied to the open invoice.

Example Payment Data Fields:
‘id’ int(10) unsigned NOT NULL AUTO_INCREMENT,
‘order_id’ int(10) unsigned NOT NULL,
‘amount’ decimal(8,2) NOT NULL,
‘currency’ varchar(255) COLLATE utf8mb4_unicode_ci DEFAULT NULL,
‘gateway’ varchar(255) COLLATE utf8mb4_unicode_ci DEFAULT NULL,
‘gateway_transaction_id’ varchar(255) COLLATE utf8mb4_unicode_ci DEFAULT NULL,
‘payment method’ varchar(255) COLLATE utf8mb4_unicode_ci NOT NULL,
‘payment token’ varchar(255) COLLATE utf8mb4_unicode_ci NOT NULL,
‘cc_type’ varchar(255) COLLATE utf8mb4_unicode_ci DEFAULT NULL,
‘cc_last_four’ varchar(10) COLLATE utf8mb4_unicode_ci DEFAULT NULL,
‘status’ varchar(255) COLLATE utf8mb4_unicode_ci DEFAULT NULL,
‘export_status’ int(11) NOT NULL DEFAULT ‘0’,
‘created_at’ timestamp NULL DEFAULT NULL,
‘updated_at’ timestamp NULL DEFAULT NULL,

(*) In various embodiments, Knectors can add fields to hold the unique identifiers from 3rd Party Applications, which can allow for mapping of a single order between multiple systems using multiple identifiers.

Fulfillment data point 324: Fulfillment records 324 can represent a physical shipment or digital delivery of an Order 318 placed on an e-Commerce website. Fulfillments 324 can originate in an ERP or other warehouse application, and in some examples, must be transmitted to the e-Commerce website in order to complete the customer's Order. A Fulfillment record 324 can belong to an Order 318 and can have many Fulfillment Items. In some embodiments, if there are multiple shipments to one or more addresses, multiple Fulfillment records 324 can be created in Knect and transmitted to the e-Commerce website.

Example Fulfillment Data Fields:
‘id’ int(10) unsigned NOT NULL AUTO_INCREMENT,
‘order_id’ int(10) unsigned NOT NULL,
‘tracking_company’ varchar(255) COLLATE utf8mb4_unicode_ci NOT NULL,
‘tracking_number’ varchar(255) COLLATE utf8mb4_unicode_ci NOT NULL,
‘export_status’ int(10) unsigned NOT NULL DEFAULT ‘0’,
‘created_at’ timestamp NULL DEFAULT NULL,
‘updated_at’ timestamp NULL DEFAULT NULL,

(*) In various embodiments, Knectors can add fields to hold the unique identifiers from 3rd Party Applications, which can allow for mapping of a single order between multiple systems using multiple identifiers.

Fulfillment Items (not illustrated): In some examples, Fulfillment Item records can represent line items in any shipment or digital delivery. Fulfillment Items can belong to exactly one Fulfillment record 324 and can have an equivalent record Order Item 318. In some embodiments, when there is an equivalent Fulfillment Item for every Order Item in matching quantities, the Order 318 is considered fulfilled.

Example Fulfillment Item Data Fields:
‘id’ int(10) unsigned NOT NULL AUTO_INCREMENT,
‘fulfillment_id’ int(10) unsigned NOT NULL,
‘orderitem_id’ int(10) unsigned NOT NULL,
‘qty_fulfilled’ int(11) NOT NULL,
‘created_at’ timestamp NULL DEFAULT NULL,
‘updated_at’ timestamp NULL DEFAULT NULL,

Inventory Item data point 328: Inventory Items 328 can represent items for sale on the e-Commerce website where physical or digital inventory is tracked and bound to a number. The source of data for Inventory Items 328 can be the e-Commerce website. As items are added to or removed from the catalog on the e-Commerce website, the Inventory Item record 328 in Knect can be created or removed to match. Order Items and Fulfillment Items can represent a product described by an Inventory Item 328 at a point in time, but in various examples, there is no dependency relationship built between them as the e-Commerce website can be considered the authoritative source for both Orders and Inventory Items.

Example Inventory Item Data Fields:
‘id’ int(10) unsigned NOT NULL AUTO_INCREMENT,
‘sku’ varchar(255) COLLATE utf8mb4_unicode_ci DEFAULT NULL,
‘qty’ int(11) NOT NULL DEFAULT ‘0’,
‘product_name’ varchar(255) COLLATE utf8mb4_unicode_ci DEFAULT NULL,
‘product_img_url’ varchar(255) COLLATE utf8mb4_unicode_ci DEFAULT NULL,
‘export_status’ int(10) unsigned NOT NULL DEFAULT ‘1’,
‘created_at’ timestamp NULL DEFAULT NULL,
‘updated_at’ timestamp NULL DEFAULT NULL,

(*) In various embodiments, Knectors can add fields to hold the unique identifiers from 3rd Party Applications, which can allow for mapping of a single order between multiple systems using multiple identifiers.

Inventory Level data point 330: An Inventory Level attribute 330 can represent the inventory number associated with an Inventory Item record 328. The ERP or warehouse application, in various examples, can be the authoritative source for this information. In some embodiments, Knect can regularly update its list of Inventory Items 328 with an Inventory Level 330 from the ERP and can then transmit this data to the e-Commerce website to establish accurate stock levels for sale on the website. In some aspects, Inventory Level for each Inventory Item can be held in the ‘qty’ data field of the Inventory Item in some examples.

Product data point 332: Product records 332 can hold static information about a catalog product that a company wishes to have integrated from the ERP or WMS to the e-Commerce Website. In various examples, these can be specs about the product which are not later embellished or re-interpreted by a sales and marketing team on the website. Products 332 can have many Inventory Items 328 in various embodiments.

Example Product Data Fields:
‘id’ int(10) unsigned NOT NULL AUTO_INCREMENT,
‘sku’ varchar(255) COLLATE utf8mb4_unicode_ci DEFAULT NULL,
‘qty’ int(11) NOT NULL DEFAULT ‘0’,
‘product_name’ varchar(255) COLLATE utf8mb4_unicode_ci DEFAULT NULL,
‘product_type’ varchar(255) COLLATE utf8mb4_unicode_ci DEFAULT NULL,
‘product_weight’ decimal(8,2) NOT NULL,
‘product_description’ varchar(255) COLLATE utf8mb4_unicode_ci DEFAULT NULL,
‘product_img_url’ varchar(255) COLLATE utf8mb4_unicode_ci DEFAULT NULL,
‘product_dimensions’ varchar(255) COLLATE utf8mb4_unicode_ci DEFAULT NULL,
‘product_origin’ varchar(255) COLLATE utf8mb4_unicode_ci DEFAULT NULL,
‘export_status’ int(11) NOT NULL DEFAULT ‘0’,
‘created_at’ timestamp NULL DEFAULT NULL,
‘updated_at’ timestamp NULL DEFAULT NULL,

(*) In various embodiments, Knectors can add fields to hold the unique identifiers from 3rd Party Applications, which can allow for mapping of a single order between multiple systems using multiple identifiers.

Payment Method data point 334: Payment Method records 334 can be a definition of equivalent fields between 2 separate business applications. Payment Methods 334 in some examples are defined by an identifier code that is unique the business application. With unique identifier codes in different applications, a mapping system can be used in some embodiments to translate payment information from one application to another. It is possible in some examples for different identifier codes from the source system (e-Commerce Website) to map to a single identifier code in the target system (ERP).

Example Payment Method Data Fields:
‘id’ int(10) unsigned NOT NULL AUTO_INCREMENT,
‘import_system’ varchar(255) COLLATE utf8mb4_unicode_ci NOT NULL,
‘import_code’ varchar(255) COLLATE utf8mb4_unicode_ci NOT NULL,
‘export_code’ varchar(255) COLLATE utf8mb4_unicode_ci NOT NULL,
‘export_system’ varchar(255) COLLATE utf8mb4_unicode_ci NOT NULL,
‘enabled’ tinyint(1) NOT NULL DEFAULT ‘0’,
‘created_at’ timestamp NULL DEFAULT NULL,
‘updated_at’ timestamp NULL DEFAULT NULL,

Shipment Method data point 336: Shipment Method records 336 can be a definition of equivalent fields between 2 separate business applications. Shipment Methods 336 in some examples can be defined by an identifier code that is unique the business application. With unique identifier codes in different applications, a mapping system can be necessary in some embodiments to translate fulfillment information from one application to another. It is possible in various examples for different identifier codes from the source system (ERP) to map to a single identifier code in the target system (e-Commerce Website).

Example Shipment Method Data Fields:
‘id’ int(10) unsigned NOT NULL AUTO_INCREMENT,
‘import_system’ varchar(255) COLLATE utf8mb4_unicode_ci NOT NULL,
‘import_code’ varchar(255) COLLATE utf8mb4_unicode_ci NOT NULL,
‘export_code’ varchar(255) COLLATE utf8mb4_unicode_ci NOT NULL,
‘export_system’ varchar(255) COLLATE utf8mb4_unicode_ci NOT NULL,
‘enabled’ tinyint(1) NOT NULL DEFAULT ‘0’,
‘created_at’ timestamp NULL DEFAULT NULL,
‘updated_at’ timestamp NULL DEFAULT NULL,

The following data points may be stored and maintained by the integration platform itself, such as in database 242 of integration platform 202.

Settings: Settings records in some examples can contain configuration key=>value pairs for each of the Knectors installed in the implementation. These can be API keys, timeout limits, server addresses, etc. Keeping settings for each individual Knector in the Knect database can for the end user to update settings as needed, without changes to the code base.

Example Settings Data Fields:
‘id’ int(10) unsigned NOT NULL AUTO_INCREMENT,
‘group’ varchar(255) COLLATE utf8mb4_unicode_ci DEFAULT NULL,
‘name’ varchar(255) COLLATE utf8mb4_unicode_ci NOT NULL,
‘value’ varchar(255) COLLATE utf8mb4_unicode_ci DEFAULT NULL,
‘created_at’ timestamp NULL DEFAULT NULL,
‘updated_at’ timestamp NULL DEFAULT NULL,

Schedules: Schedules records can contain pre-defined integration processes and time intervals at which those processes are to be run. In some examples, if the implementation is designed to import new orders from an e-Commerce system every ten minutes, there will be a schedule record created for the OrderImport process to run at that interval (e.g., defined in standard cron notation as */10 * * * *).

Example Schedules Data Fields:
‘id’ int(10) unsigned NOT NULL AUTO_INCREMENT,
‘group’ varchar(255) COLLATE utf8mb4_unicode_ci DEFAULT NULL,
‘command’ varchar(255) COLLATE utf8mb4_unicode_ci NOT NULL,
‘cron_expression’ varchar(255) COLLATE utf8mb4_unicode_ci NOT NULL,
‘enabled’ tinyint(1) NOT NULL,
‘created_at’ timestamp NULL DEFAULT NULL,
‘updated_at’ timestamp NULL DEFAULT NULL,

Tax Rates: Tax Rates can set default taxation rates for a tax zone. In some embodiments, Tax Rate records can be necessary for Orders to export to certain ERP systems. 3rd party applications can capable of calculating their own sales tax amounts, however mapping a state or zip code from a shipping address to a coded tax zone in another application can require a translation table in some examples. In various cases, the proper Tax Rate record will identify the correct code to be exported along with the rest of the Order data.

Example Tax Rates Data Fields:
‘id’ int(10) unsigned NOT NULL AUTO_INCREMENT,
‘region_code’ varchar(255) COLLATE utf8mb4_unicode_ci DEFAULT NULL,
‘rate’ decimal(8,2) NOT NULL,
‘enabled’ tinyint(1) NOT NULL,
‘created_at’ timestamp NULL DEFAULT NULL,
‘updated_at’ timestamp NULL DEFAULT NULL,

Users: User records can represent the admin users that are enabled for each instance of Knect. In various embodiments, individual users may log into Knect to check status, review details, and correct any data discrepancies that may occur over time. Users belong to one Role in various examples.

Example Users Data Fields:
‘id’ int(10) unsigned NOT NULL AUTO_INCREMENT,
‘name’ varchar(255) COLLATE utf8mb4_unicode_ci NOT NULL,
‘email’ varchar(255) COLLATE utf8mb4_unicode_ci NOT NULL,
‘email_verified_at’ timestamp NULL DEFAULT NULL,
‘password’ varchar(255) COLLATE utf8mb4_unicode_ci NOT NULL,
‘remember_token’ varchar(100) COLLATE utf8mb4_unicode_ci DEFAULT NULL,
‘created_at’ timestamp NULL DEFAULT NULL,
‘updated_at’ timestamp NULL DEFAULT NULL,

Roles: Roles can define the group of access rules that can be assigned to a User. Some users may need read-only access to Knect and some may need full write-access. Roles can have many Users and have many Permissions in various examples.

Example Roles Data Fields:
‘id’ int(10) unsigned NOT NULL AUTO_INCREMENT,
‘slug’ varchar(255) COLLATE utf8mb4_unicode_ci NOT NULL,
‘name’ varchar(255) COLLATE utf8mb4_unicode_ci DEFAULT NULL,
‘created_at’ timestamp NULL DEFAULT NULL,
‘updated_at’ timestamp NULL DEFAULT NULL,

Permissions: Permission records can define the distinct actions that a User can accomplish in Knect. For example, this can be simply logging in or it can mean changing data or creating a new User. Permissions can belong to many Roles in various examples.

Example Permissions Data Fields:
‘role_id’ int(10) unsigned NOT NULL,
‘permission_slug’ varchar(255) COLLATE utf8mb4_unicode_ci NOT NULL,
‘created_at’ timestamp NULL DEFAULT NULL,
‘updated_at’ timestamp NULL DEFAULT NULL,

Actions: Action records can log the triggered or scheduled actions of Knect. In some embodiments, every time a data point is imported, exported, or processed, the action and its corresponding 3rd party application are logged along with the execution time. This data can be used for troubleshooting the integration as well as creating statistics for the Knect dashboard.

Example Action Data Fields:
‘id’ int(10) unsigned NOT NULL AUTO_INCREMENT,
‘entity_type’ varchar(255) COLLATE utf8mb4_unicode_ci NOT NULL,
‘system’ varchar(255) COLLATE utf8mb4_unicode_ci NOT NULL,
‘action’ enum(‘import’,‘export’) COLLATE utf8mb4_unicode_ci NOT NULL,
‘result’ varchar(255) COLLATE utf8mb4_unicode_ci NOT NULL,
‘message’ varchar(1024) COLLATE utf8mb4_unicode_ci DEFAULT NULL,
‘duration’ int(10) unsigned DEFAULT NULL,
‘entity_count’ int(10) unsigned DEFAULT NULL,
‘created_at’ timestamp NULL DEFAULT NULL,
‘updated_at’ timestamp NULL DEFAULT NULL,

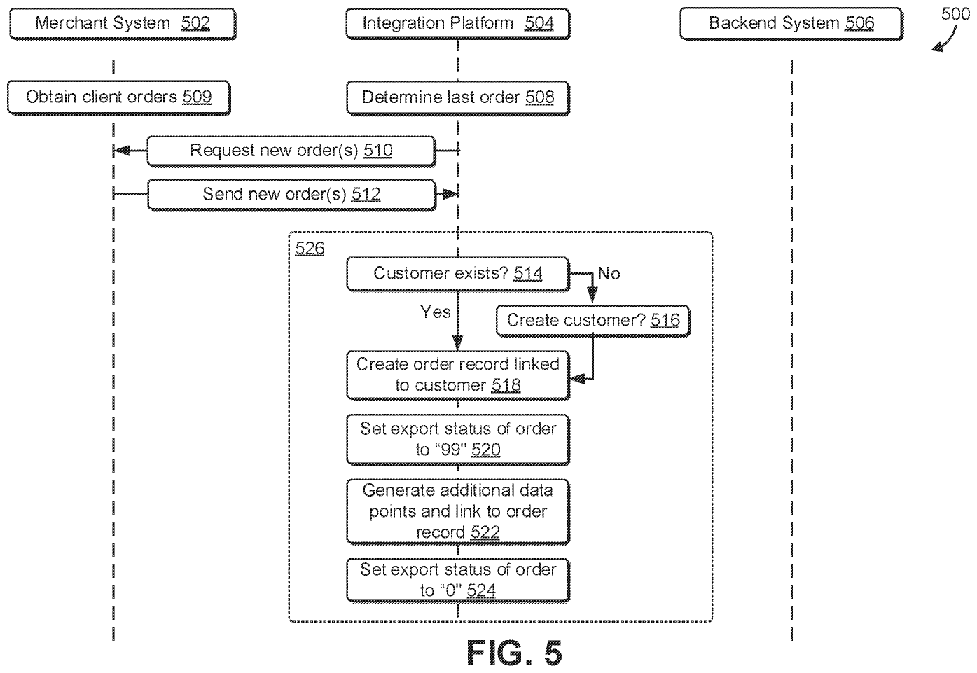

The following examples processes, as described in reference to FIGS. 5-9, are provided for purposes of illustration of some embodiments and should not be construed as limiting. In further embodiments, elements described in these examples can be absent, modified or interchangeable in various suitable ways. In some aspects, various processes, such as process 500, 600, 700, 800, and/or 900 may be carried out according to a schedule, such that they are performed by the integration platform at regular or pre-defined intervals. In other cases, one or more of these processes may be initiated based on the occurrence of a trigger event (other than based on a schedule). In various embodiments, the Scheduled Action implementation style depends on a pre-defined set of scheduled actions that execute integrations at regular intervals, such as may generally be set at a certain number of minutes past the hour. Or at other regular time intervals. In some examples, as each integration segment logically follows another, the Schedule Actions method can require that the scheduled events be defined in a likewise logical and sequential manner.

FIG. 5 illustrates an example process 500 for importing an order from a merchant system by an integration platform. In some aspects, operations of process 500 may be performed by a merchant system 502, integration platform 504, and/or a backend system 506, which may include one or more aspects of merchant system 102, integration platform 120, 202, and/or a backend system 112, as described above in reference to FIGS. 1 and 2.

In one aspect, process 500 may be initiated at a pre-scheduled interval, such as every 10 minutes. Process 500 may begin at operation 508, in which the integration platform 504 may determine the last known Order record to be imported from the e-Commerce or merchant system, such querying its own database, such as database 242.

The merchant system 502 may concurrently be receiving or obtaining new client orders at operation 509. Next, the integration platform 504 may query the merchant system, such as via an API via a request (e.g., secure HTTP request using Guzzle, cURL) for all orders placed since the last known Order record, at operation 510.

If there are new Order records to import, the data can be returned at operation 512 (e.g., via a secure HTTP response) and can include the data fields described in Customers, Orders, Order Items, Addresses, and Payments. In some cases, child records may be linked via separate API endpoints rather than being returned in the API response payload. In this example case, the integration platform 504 may make subsequent requests to these linked endpoints in order to retrieve the data.

For each Order record retrieved, the integration platform 504 may compares the customer information—specifically the email address—to determine if the Customer record already exists in the integration platform records, at operation 514. If there is no existing record, then a new Customer may be created at operation 516. The new customer ID, or if the email address already exists in integration platform 504, the existing Customer ID, may be used to process the Order. Linking the customer ID in this way can allow the Order to be matched to the Customer's unique identifiers in each 3rd party business application where the Customer may already exist.

Once the Customer is identified or created, the Order and Order Items and their respective data fields, including any unique identifiers added by a connector, are created in the integration platform database, such as database 242, at operation 518. The Order may be given an ‘export_status’ value of 99 at this point to prevent it from exporting anywhere with only partial data being available, at operation 520. It should be appreciated that the actual value is only given by way of example, and that other values or indicators may be used to indicate that the record is not complete and is not ready to export to another system.

After successful creation of the Order record and Order Items, the billing and shipping Addresses may be created in the integration platform database and linked to the Order record, at operation 522. Also at operation 522, after successful creation of Addresses, the Payment records may also be created in the integration platform database and linked to the Order record. The Order record status may now be set to an ‘export_status’ value of 0, at operation 524, making it available for export to a target backend system such as an ERP, CRM, POS, or WMS. It should be appreciated that the actual value is only given by way of example, and that other values or indicators may be used to indicate that the record is not complete and is not ready to export to another system.

Operations 514, 516 (as needed), 518, 520, 522, and 524 may then be repeated (indicated via loop 526) for each new order received at operation 512, until there are no more new orders or a configurable setting for the order import limit has been reached.

It should be appreciated that the specific data points identified above are given by way of example, and that additional or less data points may be sued to a similar effect to effectuate importing an order and linking it to associated information usable to complete the order and process fulfillment of the order.

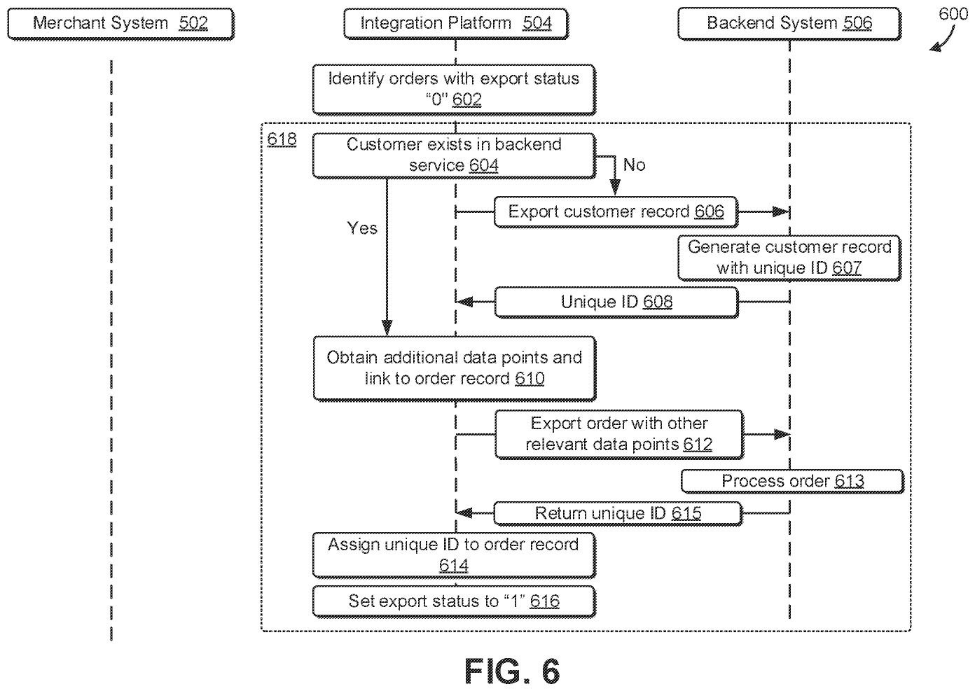

FIG. 6 illustrates an example process 600 for exporting an order to a backend system by an integration platform. In some aspects, operations of process 600 may be performed by a merchant system 502, integration platform 504, and/or a backend system 506, which may include one or more aspects of merchant system 102, integration platform 120, 202, and/or a backend system 112, as described above in reference to FIGS. 1 and 2.

In one aspect, process 600 may be initiated at a pre-scheduled interval, such as every 10 minutes. Process 600 may begin at operation 602, in which the integration platform 504 may identify all stored order records (e.g., in a database, such as database 242 maintained by the integration platform) with an ‘export_status’ value of 0, or which otherwise indicate that they are ready for export to a backend system.

For each Order record in this collection, the integration platform 504 may then determine, at operation 604, whether or not the Customer exists in the backend system by searching for the unique identifier on the Customer record pertaining to the backend system. If none is found, the integration platform 504 may export the Customer record to the backend system (e.g., via an API using secure HTTP requests, such as Guzzle, cURL, etc.) at operation 606. The backend system 506 may then generate a customer record with a unique ID at operation 607, and return the unique ID at operation 608, which the integration platform 504 may then store.

In some aspects, the integration platform 504 may obtain additional data points that are linked to the order record/customer record, such as Order Items, Addresses, and Payments (including all of the data fields for each data entity), at operation 610, and may export those data points to the backend system, such as using an API using secure HTTP requests via Guzzle, or cURL, at operation 612. The backend system 506 may process the order 613 and return a unique ID at operation 615 associated with the order in the backend system. The integration platform 504 may assign the returned unique identifier to its own Order record for future use, at operation 614. In this process, the integration platform may translate Shipment Methods, Payment Methods, and Tax Rates as necessary. The translation values may be mapped from the respective tables for Shipment Methods, Payment Methods, and Tax Rates.

Upon successful export, the integration platform 504 may update its own Order record with an ‘export_status’ value of 1 to represent that the record has been exported to the backend system. In some cases, operations 604, 606, 607, 608, 610, 612, 613, 615, 614, and 616 may be repeated (indicated via loop 618) until all orders ready for export (e.g., with an export status of “0”) or a configurable Setting for the order export limit has been reached.

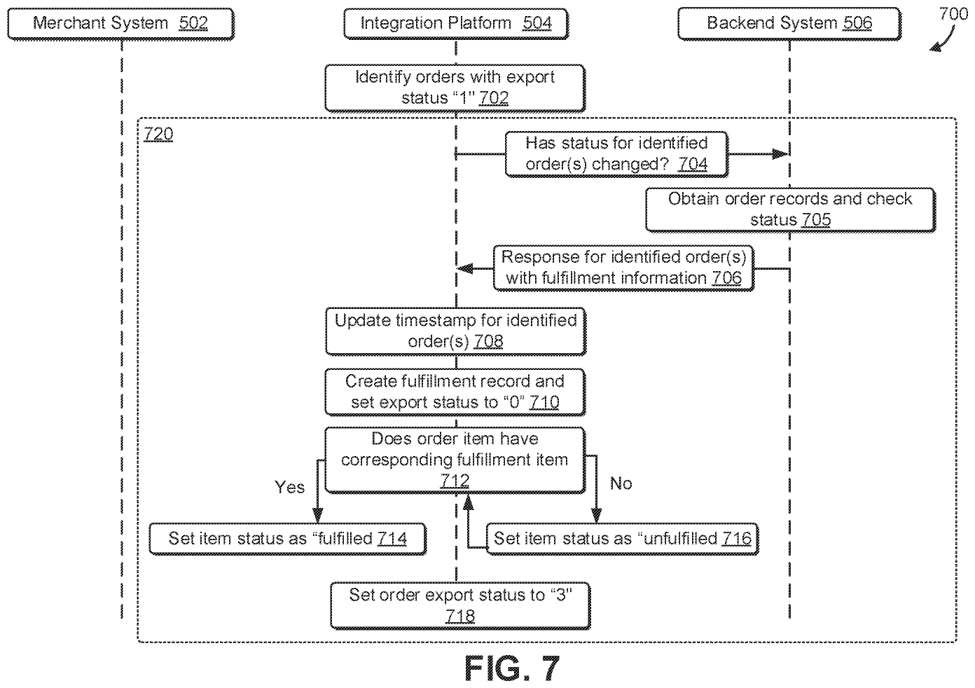

FIG. 7 illustrates an example process 700 for importing a fulfilment record from a backend system by an integration platform. In some aspects, operations of process 700 may be performed by a merchant system 502, integration platform 504, and/or a backend system 506, which may include one or more aspects of merchant system 102, integration platform 120, 202, and/or a backend system 112, as described above in reference to FIGS. 1 and 2.

In one aspect, process 700 may be initiated at a pre-scheduled interval, such as every hour. Process 700 may begin at operation 702, in which the integration platform 504 may identify orders, such as in its own database 242, having an export status or “1” or have been successfully exported to a backend system.

For each Order identified, the integration platform 504 may query the backend system (e.g., querying the API using secure HTTP requests [Guzzle, cURL]) to determine if a status has been changed or if a fulfillment has been added to this Order, at operation 704. In response, the backend system 506 may obtain order records and check their status at operation 705. The backland system 506 may then transmit a response to the integration platform 504 for the identified orders with fulfillment information, at operation 706.

Once an Order has been checked, its updated_at timestamp may be set to the current time to prevent repeat checks happening prematurely, at operation 708.

When a new fulfillment is found via querying the backend system, the integration platform may create a Fulfillment record in its own database, at operation 710 and set its export_status to 0.

As a final step in this integration, the integration platform 504 may compare its own Order record and Fulfillment record to determine if all of the Order Items now have a corresponding Fulfillment Item. When an Order Item does have a corresponding Fulfillment Item, the Order Item's fulfillment status data field is set to fulfilled, at operation 714. If not, process 700 may continue to loop back to operation 712 or 702 and continue to loop through until all order items have a corresponding fulfillment item. .

If all the Order Item records have a corresponding Fulfillment Item from the current execution or a previous one, the Order record export_status may be set to a value of ‘3’ to indicate that the order has been fulfilled. In some cases, operations 704, 705, 706, 708, 710, 712, 714, 716, and 718 may be repeated, as indicated via loop 720, until there are no more orders with ‘export_status’ of 1 or the configurable Setting for the fulfillment import limit has been reached.

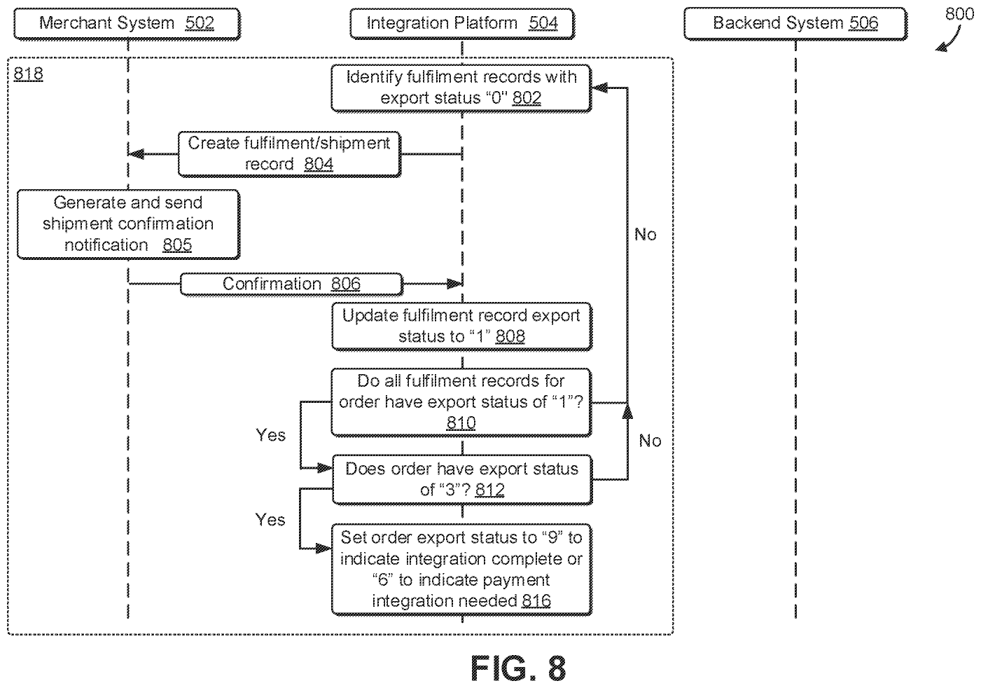

FIG. 8 illustrates an example process 800 for exporting a fulfilment record to a merchant system by an integration platform. In some aspects, operations of process 800 may be performed by a merchant system 502, integration platform 504, and/or a backend system 506, which may include one or more aspects of merchant system 102, integration platform 120, 202, and/or a backend system 112, as described above in reference to FIGS. 1 and 2.

In one aspect, process 800 may be initiated at a pre-scheduled interval, such as every hour. Process 800 may begin at operation 802, in which the integration platform 504 may identify fulfillment records, such as in its own database 242, having an export status or “0” or have been successfully imported from the backend system 506.

For each Fulfillment record identified, the integration platform 504 may create a fulfillment or shipment record in the merchant system 502, such as via its API using secure HTTP requests [Guzzle, cURL]. This action will generally trigger the merchant system 502 to generate and send a shipment confirmation notification to the user/customer, which may include carrier and tracking information for the shipment, at operation 805.

Upon successful creation of the fulfillment or shipment in the merchant system 502, and receipt of confirmation 806, the integration platform 504 may updates its own database so that the Fulfillment record has an ‘export_status’ value of 1, at operation 808.

When all Fulfillment records for an Order have an ‘export_status’ value of 1, as determined at operation 810, and the Order record has an ‘export_status’ of 3, as determined at operation 812, the Order is completely fulfilled, and all related Fulfillment records have been exported. In this scenario, the integration platform 504 may set the Order record's ‘export_status’ value to 9 if there are no more integrations to complete, or to “6” if there is still a payment integration to complete. If, however, all fulfillment records do not equal “1” or the order export status is not “3,” then process 800 may loop back to operation 802. In the case a payment process still needs to occur, which may be determined by the merchant's financial process, as indicated by an export status of “6,” then process 900 may be performed, as will be descried in greater detail below.

Process 800 may loop through operations 802, 804, 805, 806, 808, 810, 812, and 816, as indicated via loop 818, until there are no more Fulfillment records with ‘export_status’ of 0 or the configurable Setting for the fulfillment export limit has been reached.

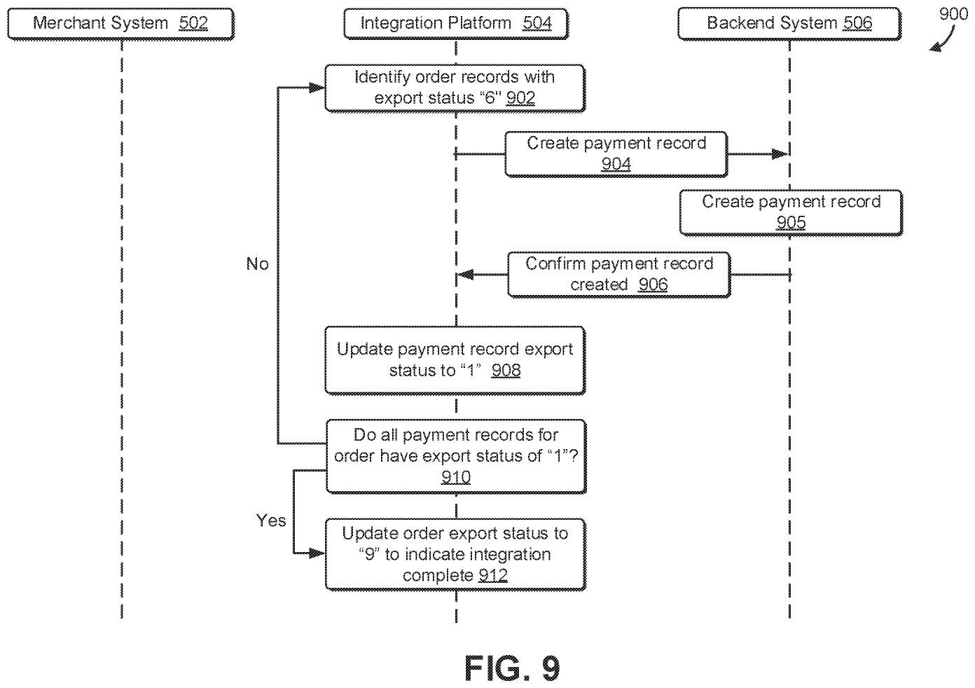

FIG. 9 illustrates an example process 900 for processing payment by a backend system in coordination with an integration platform. In some aspects, operations of process 900 may be performed by a merchant system 502, integration platform 504, and/or a backend system 506, which may include one or more aspects of merchant system 102, integration platform 120, 202, and/or a backend system 112, as described above in reference to FIGS. 1 and 2.

In some backend or ERP systems, invoices for Orders are not created until the Order has been fulfilled by the warehouse. Without an invoice to apply a payment to, full automation is generally not possible. For merchants in this workflow, the integration platform may hold Payment records in its own database until the Order record has reached an ‘export_status’ value of 6, representing that all Order Items have been fulfilled and the Fulfillment has been created in the e-Commerce Website.

Periodically, such as every hour, the integration platform may identify order records with an export status of “6” in its own database, at operation 902. For each Order identified, the integration platform 504 may create a payment record in the backend or ERP system 506 at operation 904 (e.g., via an API via secure HTTP request [Guzzle, cURL]). This can include multiple queries to the backend or ERP system 506 as the Invoice identifier is generally not known ahead but can be located using the ERP's unique identifier for the Order record.

Upon successful creation of the payment in the ERP system, at operation 905, and confirmation thereof at operation 906, the integration platform 504 may update its own database so that the payment record has an ‘export_status’ value of 1, at operation 908.

If all Payment records for an Order have an ‘export_status’ value of 1, as determined at operation 910, the integration platform 504 may update its own database so that the Order record's ‘export_status’ value is 9 reflecting that all integrations are complete, at operation 912. If all payment records for the order do not have an export status of “1”, then process 900 may loop back to operation 902.

In some aspects, the integration platform 504 may interface with payment gateways systems (which may generally be classified as a backend system 506) to facilitate processing payment for orders made through the merchant system 502. By offering this integration via the integration platform 504, the integration platform 504 can solve another challenge: most websites/merchant systems 502 will authorize and capture funds in one step at the point of purchase. For example, according to Visa's terms and the FTC, a card authorization should be generated at the time of purchase but funds should not be captured until the order is fulfilled. Authorizations usually last about 7 days. For merchants making custom products or with an extended fulfillment window, these requirements put many merchants out of compliance if their e-commerce platform only supports authorization and funds capture at the time of purchase.

By implementing a connector or data interface to one or multiple online payment gateways, the integration platform 504 may enable backend system 506 to trigger the capturing of funds, the capturing of a partial amount of funds from the authorization (necessary when there are backordered items, or multiple shipments), and re-authorization of an uncaptured amount (useful for long lead team custom orders and/or orders with variable costs such as repair services). In some aspects, this payment flow may add a final operation to an order transmission. Along with the shipment information being sent from integration platform 504 to the merchant system 502/e-commerce website, the integration platform 504 will also send funds capture instructions to an online payment gateway (e.g., another backend system 506) and record the result internally. Any additional confirmation steps back to a different backend system 506 or ERP system or merchant system 506/e-commerce website may be managed through the custom layer or a custom connector, as there may be a great deal of variance from one merchant to another.

In other cases, other processes may be similarly performed by the integration platform 504 in conjunction with the merchant system 502 and backend system 506. In a first example, an inventory item may be imported from a merchant system to the integration platform via a scheduled action. In this example, once per day, or at some other configurable interval, the integration platform may queries the merchant system to retrieve all active products (e.g., inventory items). For each Inventory Item in the collection, the integration platform compares the item's sku to its own database to determine if the Inventory Item is known to the integration platform. When an Inventory Item is not found in the integration platform, it will be created as a new Inventory Item record and given a default Inventory Level value of 0. This process may be repeated until there are no more Inventory Item records with in the collection from the merchant system.

In another example, an inventory level may be imported from a backend/ERP system to the integration platform via a scheduled action. In this example, at a configurable interval, such as several times per day, the integration platform may refer to its own database to retrieve a collection of inventory items that have had the longest amount of time (or a configurable amount of time) since their last inventory level update. The size of this collection may be a configurable setting and may be determined by the size of the merchant's catalog. Small catalogs of 200 skus may have the entire catalog updated several times a day. Large catalogs of 20,000 skus will generally be updated at longer intervals, unless the integration platform is running in a highly scalable mode (*). For each item in the collection of Inventory Item records, the integration platform will query the ERP/backend system to retrieve the last known or current inventory level. If the last known or current inventory level is different than the value in the integration platform, the integration platform may update its own database to the inventory level retrieved from the ERP/backend system and set the ‘export_status’ value to 0. This process may be repeated until there are no more Inventory Item records in the collection from the integration platform.

In another example, the inventory level may be exported from the integration platform to merchant system via a scheduled action. In some cases, several times a day, or at some other configurable interval, at a schedule interval that closely follows the Inventory Level Import process, the integration platform may refer to its own database to retrieve a collection of Inventory Items with an ‘export_status’ value of 0. For each item in the collection of Inventory Item records, the integration platform may update the inventory level on the merchant system. Upon successful update to the merchant system, the integration platform may update its own database so that the ‘export_status’ value is 1. If by chance an error response is returned from the merchant system, the integration platform may presume that the Inventory Item is no longer available on the merchant system and the integration platform may remove the Inventory Item record from its own database. This process may be repeated until there are no more Inventory Item records in the collection from the integration platform.

In another example, a product item may be imported from the merchant system to integration platform via a scheduled action. This process may be identical to the Inventory Item Import process, but rather updates the Product records instead.

In another example, product data may be imported from a backend system/ERP to the integration platform via a scheduled action. At least once per day, or at some other configurable interval, the integration platform may refer to its own database to retrieve a collection of Product records that have had longest amount of time since their last data field value update. The size of this collection is a configurable setting and may be determined by the size of the merchant's catalog. Small catalogs of 200 skus will see the entire catalog updated several times per day. Large catalogs of 20,000 skus will generally be updated at longer intervals, unless Integration platform is running in a highly scalable mode (*). For each item in the collection of Product records, the integration platform may query the ERP/backend system to retrieve the current values for product data attributes. Typical product attributes for this integration may include MSRP, weight, dimensions, unit of measure, basic description, country of origin, etc. The integration platform may update its own database to the Product attribute values retrieved from the ERP/backend system and sets the ‘export_status’ value to 0. This process may be repeated until there are no more Product records in the collection from the integration platform.

In another example, product data may be exported from the integration platform to the merchant system via a scheduled action. At least once per day, or at some other configurable interval, at a schedule interval that closely follows the Product Data Import process, the integration platform may refer to its own database to retrieve a collection of Product records with an ‘export_status’ value of 0. For each item in the collection of Product records, the integration platform may update the product attribute values on the merchant system. Upon successful update to the merchant system, the integration platform may update its own database so that the Product record ‘export_status’ value is 1. If by chance an error response is returned from the merchant system, the integration platform presumes that the Product is no longer available on the merchant system and the integration platform removes the Product record from its own database. This process may be repeated until there are no more Product records in the collection from the integration platform. With this capability, the integration platform can automate the population of entire product catalogs into an e-Commerce website or merchant system from other backend systems. This process may be similar to the inventory management process already described, just with support for more data points.

In some cases, the integration platform may direct product information concerning certain or selected products to different end points. In some aspects, this may include sending product information of certain products to different locations accessible via a single merchant system (e.g., different countries where goods and services are sold, but offered in those different countries by the same merchant). In other aspects, this may include sending product information of different products to different merchant systems or websites. In yet other cases, this may include sending different product details for the same product or products to different locations of single merchant, or to different merchants (e.g., this could be for the same product description in different languages, the same product description with different units of measurement such as metric v. standard, and/o for different product descriptions). The end points and which information is sent to those end points can be managed through the integration platform itself, such as by a seller or administrator. Below are provided a few concrete examples of various operations that can be performed by the integration platform in various workflows.

Example 1: Order Import from Merchant X to Knect via Triggered Action. Merchant X supports webhooks, meaning that it can send secure HTTP request to a pre-defined URL with some additional parameters every time a configured event occurs in Merchant X. Merchant X can be specifically configured to call Knect every time an order is placed and deliver that order number to Knect. When Knect receives the webhook notification of a new Order from Merchant X via secure HTTP request, Knect triggers its normal Order Import Action but is only requesting the Order data from Merchant X around that single Order. Given the new Order number or identifier, Knect requests the details via secure HTTP request [Guzzle, cURL] and the data is returned will include the data fields described in Customers, Orders, Order Items, Addresses, and Payments. Occasionally, child records are linked via separate API endpoints rather than being returned in the API response payload. In this case Knect makes subsequent secure HTTP requests [Guzzle, cURL] to these linked endpoints in order to retrieve the data.

For each Order record retrieved, Knect compares the customer information—specifically the email address—to determine if the Customer record already exists in Knect. If there is no existing record, then Knect creates a new Customer. If the email address already exists in Knect, the existing Customer ID is used to process the Order. This allows the Order to be matched to the Customer's unique identifiers in each 3rd party business application where the Customer may already exist. Once the Customer is identified or created, the Order and Order Items and their respective data fields, including any unique identifiers added by a Knector, are created in the Knect database [My SQL]. The Order is given an ‘export_status’ value of 99 at this point to prevent it from exporting anywhere with only partial data being available.

After successful creation of the Order record and Order Items, the billing and shipping Addresses are created in the Knect database [MySQL] and linked to the Order record. After successful creation of Addresses, the Payment records are created in the Knect database [MySQL] and linked to the Order record. The Order record is set to an ‘export_status’ value of 0, making it available for export to a target system such as an ERP, CRM, POS, or WMS. In the triggered action method, a single Order is processed at a time, so no steps are repeated and no limit on the number of Orders to import is configured. The Orders will import in real time as they are placed In Merchant X.

Example 2: Inventory Level Import from Merchant Y to Knect via Scheduled Action. Some legacy ERP systems do not allow for API connectivity. Often times these systems are able to generate a static report in a CSV, XML, plain text or other file format. This output data can be placed on a server where Knect can consume the data. Several times per day Knect logs into an intermediary server via FTP and downloads a CSV file containing skus and inventory levels for a merchant's catalog. The size of this collection is a configurable Setting and is determined by the size of the merchant's catalog. Small catalogs of 200 skus will see the entire catalog updated several times a day. Large catalogs of 20,000 skus will generally be updated at longer intervals, unless Knect is running in highly scalable mode (*).

Knect parses the data file to create a collection records that can be matched by sku to the Inventory Item records in Knect. Knect references its own database to retrieve an Inventory Item record matching the sku from the data file and compare the inventory level value for that sku to Knect's value for that sku. If the last known or current inventory level is different than the value in Knect, Knect updates its own database [MySQL] to the inventory level retrieved from the ERP system and sets the ‘export_status’ value to 0. This process may be repeated repeated until there are no more records in the collection from the data file.

Example 3: Fulfillment Import from Merchant Z to Knect Scheduled Action. Every 20 minutes, Knect queries a SQL intermediary database via ODBC looking for new shipments & invoices that have been created in Merchant Z and migrated to the SQL intermediary database via the Merchant Z SmartConnect adapter. When a new fulfillment or collection of new fulfillments are found via querying the SQL intermediary database, Knect will create a Fulfillment record in its own database [MySQL] with an ‘export_status’ of 0. As a final step in this integration Knect compares its own Order record and Fulfillment record to determine if all of the Order Items now have a corresponding Fulfillment Item. When an Order Item does have a corresponding Fulfillment Item, the Order Item's ‘fulfillment_status’ data field is set to ‘fulfilled’.

If all the Order Item records have a corresponding Fulfillment Item from the current execution or a previous one, the Order record has its ‘export_status’ value update to ‘3’. Upon successful creation of the Fulfillment record in Knect and subsequent updates to Order and Order Item records, Knect will flag the corresponding shipment & invoice row in the SQL intermediary database as exported. This process may be repeated until there are no more shipments & invoices in the collection from the SQL intermediary database or the configurable Setting for the fulfillment import limit has been reached.

In some aspects, in place of or in addition to the scheduled approach described above, the integration platform may utilize a highly scalable mode in which scalable cloud computing resources may be utilized to adapt to changing loads, such as volume or orders coming from the merchant system. In some aspects, Knect can have the ability to run in an alternative cloud architecture designed to achieve high levels of scalability. For large merchants receiving hundreds of orders in a 5-minute period, the scheduled action design can create lags in data transmission and complications in tracking the state of an individual data point.

Highly Scalable mode can rely on serverless cloud technology, such as AWS Lambda, which can allow workloads to be broken into smaller individual segments that can be processed in parallel. A good example of the highly scalable challenge is the Order Import Action from a Shopify e-Commerce website to Knect.

In some embodiments, If Knect is querying the Shopify API for new Orders every minute and receives 350 new order numbers in response, it may take longer than 1 minute for Knect to import all of those orders in a synchronous, serialized manner such as the method described in ‘Order Import from e-Commerce Website to Knect via Scheduled Action’. After 1 minute, the next Order Import process can begin looking for additional new orders. This can create complication in tracking the state of each order as the individual import processes begin to overlap one another. Additionally, it can require the use of dedicated compute resources large enough to handle the simultaneous processes.

In various examples of a highly scalable design, a query to the Shopify API that results in 350 new orders is easily processed. When Knect receives the response with 350 order numbers, in various examples, it immediately places each order number on the queue to be processed by a separate worker in AWS Lambda. The action of queueing 350 orders can take less than one second and the initial process can then be complete. AWS Lambda can be configured in various examples to increase or decrease scale within seconds and can be configured to increase scale by adding worker resources when the worker queue reaches a certain threshold. An example scaling rule might be that 1 new worker is created for every 20 jobs in the queue and workers are removed when there are less than 10 jobs in the queue per existing worker.

In specific reference to the highly scaled example Shopify problem, when 350 orders are placed on the job queue AWS Lambda can create 18 worker resources (1 per 20 jobs), each running their own instance of Knect. In highly scalable mode, the Knect startup process can check the job queue for the next order waiting to be imported. Once the job is pulled off the queue, Knect can process the Order Import Action identically to if Knect had been triggered via webhook from Shopify—quickly importing a single order and all of its detail data from Shopify into its own database [MySQL].

When there are no longer enough jobs in the queue AWS Lambda can retire the worker. In various embodiments, this method not only allows for processing of a large number of transactions in real-time, it tightly aligns the cost of compute resources with the volume of transactions. When e-Commerce websites are taking many orders, the compute resources can be scaled in real-time to handle the processing, but when the website is not active, in some examples, the compute resources can reduced to zero to eliminate cost.

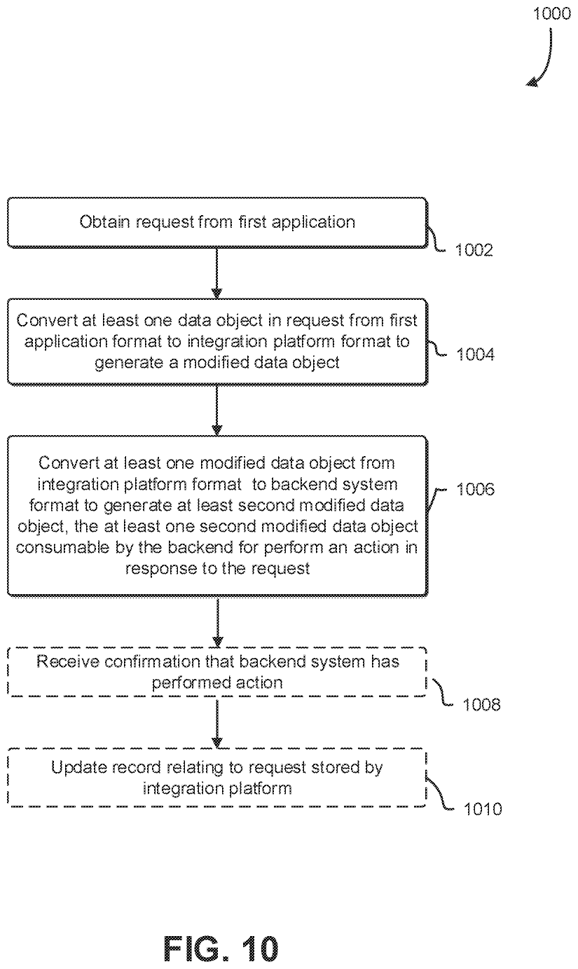

FIG. 10 illustrates an example process 1000 for converting data received from a merchant system to be usable by a backend system. Process 1000 may be performed by an integration platform, such as integration platform 120, 202, and/or 504 above, using one or more data interfaces 320, as described above in reference to FIGS. 1, 2, 3, and 5-9. As used herein, dotted lines may indicate optional, but not necessary operation, such that a process may be performed without or without the operations indicated as optional.

Process 1000 may begin with operation 1002, in which a request from a first application (e.g., a merchant system) may be obtained by an integration platform, such as using a first transmission method. In some cases, the request may include at least one data object such as relating to or specifying an order for goods or services offered for sale through a merchant system. The at least one data object in the request may then be converted from a first application format to a platform specific format using a first connector to generate at least one first modified data object, the first connector specifying the first data transmission method, at operation 1004.

Next, at operation 1006, the at least one first modified data object may be converted from the platform specific format to a first backend system format using a second connector to generate a second modified data object, wherein the second modified data object is consumable by the first backend system to perform an action in response to the request. In some cases, the action may include processing and/or fulfilling the order. In some cases, operation 1006 may be performed by the integration platform.

In some cases, the integration platform may optionally receive a confirmation that the backend system has performed the requested action, at operation 1008. In response, the integration platform may update a record, stored by the integration platform, relating to the request, such as to indicate that the action has been performed, at operation 1010. In this way, the integration may better manage the processing of orders between a merchant system and one or more backend systems, such as described in greater detail above in reference to FIGS. 5-9.

In some cases, process 1000 may additionally include converting the at least one first modified data object from the platform specific format to a second backend system format using a third connector to generate a third modified data object, wherein the third modified data object is consumable by the second backend system to perform a second action in response to the request. In some cases, the at least one first modified data object includes at least a first data field and a second data field, wherein the first data field maps to the first backend system and the second data field maps to a second backend system. In some aspects, settings for the first connector are maintained by the platform, where the settings may include at least one of an API key, a timeout limit, or a server address for the first connector.

In some case, process 1000 may further include detecting occurrence of a triggering event; and responsive to detecting the occurrence of the triggering event, at least one of: obtaining the request from the first application, converting the at least one data object from the first application format to the platform specific format, or converting the at least one first modified data object from the platform specific format to the first backend system format.

In some cases, the integration platform maintains a set of schedules, where individual schedules of the set of schedules define the trigger event and the action to be performed upon occurrence of the trigger event, the trigger event including an event relating to the data object, the first modified data object, or the second modified data object. In some aspects, the at least one data object includes a first data object that is referenced by a second data object (such as a customer and an order data point or an order and order item data point). In some cases, the first data transmission method includes one of a programming API, static file consumption, or a direct database connection.

In yet some cases, process 10000 may include selecting at least one of the first connector or the second connector based on a type associated with the data object or a characteristic of the first application. In some cases the type may indicate a characteristic of the merchant system of backend system or some characteristics of the type of request or action the data object is associated with (e.g., an order/fulfillment or an inventory or product check).

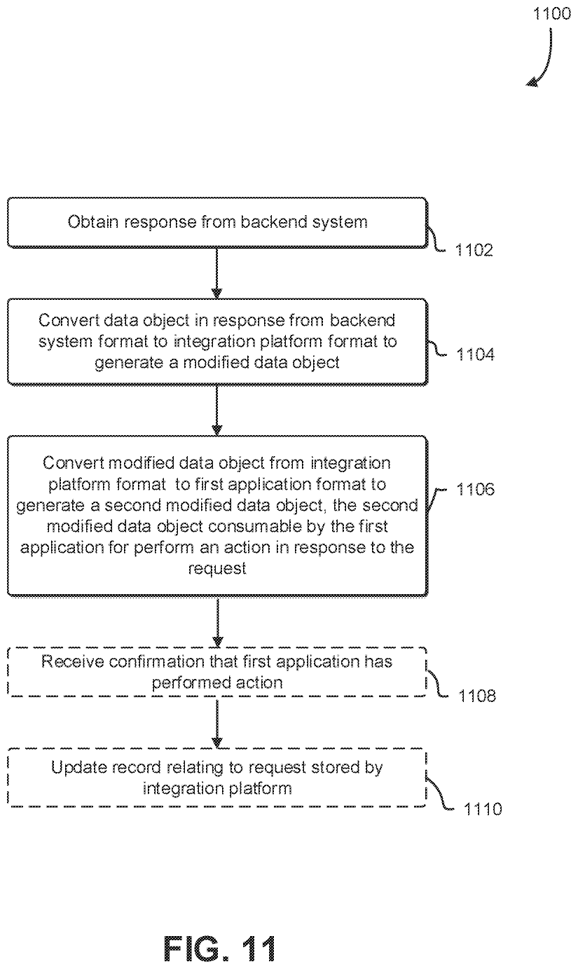

FIG. 11 illustrates an example process 1100 for converting data received from a backend system to be usable by a merchant system. Process 1100 may be performed by an integration platform, such as integration platform 120, 202, and/or 504 above, using one or more data interfaces 320, as described above in reference to FIGS. 1, 2, 3, and 5-9.

Process 1100 may begin at operation 1102, in which the integration platform may obtain a response/a second data object from the backend system.

Next, at operation 1104, the integration platform may convert the second data object from the first backend system format to the integration platform format using a third connector to generate a first modified second data object. The integration platform may additionally, at operation 1106, convert the first modified second data object from the platform specific format to the first application format using a fourth connector to generate a second modified second data object, wherein the second modified second data object is consumable by the first application to perform a second action. In yet some aspects, integration platform may optionally receive a confirmation that the first application has performed an action, such as in response to receiving the second modified data object, at operation 1108. The integration platform may then update a record, stored by the integration platform, relating to the original request to indicate that the action has been performed. In this way, the integration platform may better manage the processing of orders between a merchant system and one or more backend systems, such as described in greater detail above in reference to FIGS. 5-9.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A system, comprising:
one or more processors;
memory that stores computer-executable instructions that, when executed, cause the system to:
provide an integration platform, the integration platform comprising:
a first set of connectors, wherein individual connectors of the first set of connectors comprise first data structures usable to convert a data object between a merchant system format and an integration platform format according to a first data transmission method defined by the individual connectors; and
a second set of connectors, wherein individual connectors of the second set of connectors comprise second data structures usable to convert a data object between the platform specific format to and a backend system format according to a second data transmission method defined by the individual connectors;
obtain, by the integration platform, a request from the merchant system using a first data transmission method, the request comprising at least one data object associated with a customer order;
converting the at least one data object from the merchant system format to the integration platform format using a first connector from the first set of connectors to generate at least one first modified data object, the first connector specifying the first data transmission method; and
converting the at least one first modified data object from the integration platform format to a backend system format using a second connector from the second set of connectors to generate a second modified data object, wherein the second modified data object is consumable by the backend system to perform an action to fulfil the customer order.

2. The system of claim 1, wherein the integration platform further comprises a schedule which defines trigger events, wherein upon detecting occurrence of a trigger events of the plurality of trigger event, the integration platform initiates at least one of converting the at least one data object from the merchant system format to the integration platform or converting the at least one first modified data object from the integration platform format the backend system format.

3. The system of claim 1, wherein the first data structures comprises a first plurality of data fields of the merchant system format mapped to a second plurality of data fields of the integration platform format, and wherein the second data structures comprises a third plurality of data fields of the integration platform format mapped to a fourth plurality of data fields of the backend system format.

4. The system of claim 1, wherein the instructions that cause the system to convert the at least one first modified data object from the integration platform format to the backend system format using the second connector from the second set of connectors to generate the second modified data object further comprise instructions that further cause the system to:
generate at least open additional data point related to the customer order; and
associate the at least one additional data point to the second modified data object.

5. The system of claim 1, wherein the computer-executable instructions that, when executed, further cause the system to:
generate, by the integration platform, a record of the customer order;
receive a response from the backend system indicating that the customer order has been fulfilled; and
responsive to receiving the response, update a status of the record to indicate that the order has been fulfilled.

6. A method comprising;
obtaining, by an integration platform, a request from a first application using a first transmission method, the request comprising at least one data object;
converting the at least one data object from a first application format to a platform specific format using a first connector to generate at least one first modified data object, the first connector specifying the first data transmission method; and
converting the at least one first modified data object from the platform specific format to a first backend system format using a second connector to generate a second modified data object, wherein the second modified data object is consumable by the first backend system to perform an action in response to the request.

7. The method of claim 6, further comprising:
converting the at least one first modified data object from the platform specific format to a second backend system format using a third connector to generate a third modified data object, wherein the third modified data object is consumable by the second backend system to perform a second action in response to the request.

8. The method of claim 7, wherein the at least one first modified data object comprises at least a first data field and a second data field, wherein the first data field maps to the first backend system and the second data field maps to a second backend system.

9. The method of claim 6, wherein settings for the first connector are maintained by the platform, wherein the settings comprise at least one of an API key, a timeout limit, or a server address for the first connector.

10. The method of claim 6, further comprising:
detecting occurrence of a triggering event; and
responsive to detecting the occurrence of the triggering event, at least one of: converting the at least one data object from the first application format to the platform specific format or converting the at least one first modified data object from the platform specific format to the first backend system format.

11. The method of claim 10, wherein the platform maintains a set of schedules, wherein individual schedules of the set of schedules define the trigger event and the action to be performed upon occurrence of the trigger event, the trigger event comprising an event relating to the data object, the first modified data object, or the second modified data object

12. The method of claim 6, further comprising:
selecting at least one of the first connector or the second connector based on a type associated with the data object or a characteristic of the first application.

13. The method of claim 6, wherein the at least one data object comprises a first data object that is referenced by a second data object.

14. The method of claim 6, wherein the first data transmission method comprises one of a programming API, static file consumption, or a direct database connection.

15. The method of claim 6, further comprising:
obtaining, by the integration platform, a second data object from the first backend system;
converting the second data object from the first backend system format to the integration platform format using a third connector to generate a first modified second data object; and
converting the first modified second data object from the platform specific format to the first application format using a fourth connector to generate a second modified second data object, wherein the second modified second data object is consumable by the first application to perform a second action.

16. A non-transitory computer-readable storage medium storing thereon executable instructions that, as a result of being executed by one or more processors of a computer system, cause the computer system to at least:
obtain, by an integration platform, a request from a first application, the request comprising at least one data object associated with an order;
convert the at least one data object from a first application format to a platform specific format using a first connector to generate at least one first modified data object, the first connector specifying a plurality of linked data points that comprise the at least one first modified data object;
store, by the integration platform, a record of the at least one first modified data object, the record comprising a status of the record;
set the status to indicate that he at least one modified data object is ready to export to a backend system; and
convert the at least one first modified data object from the platform specific format to a first backend system format using a second connector to generate a second modified data object, wherein the second modified data object is consumable by the backend system to perform an action in response to the order.

17. A non-transitory computer-readable storage medium of claim 16, wherein the executable instructions that, as a result of being executed by one or more processors of a computer system, further cause the computer system to at least:
receive a response from the backend system, the response indicating that the order has been fulfilled by the backend system; and
update the status of the record to indicate that the order will be fulfilled.

18. A non-transitory computer-readable storage medium of claim 17, wherein the executable instructions that, as a result of being executed by one or more processors of a computer system, further cause the computer system to at least:
cause a fulfilment record to be generated by the first application; and
upon receiving confirmation that the fulfilment record has been generated, set the status of the order to indicate that the order is complete.

19. A non-transitory computer-readable storage medium of claim 16, wherein the executable instructions that, as a result of being executed by one or more processors of a computer system, further cause the computer system to at least:
detect occurrence of a triggering event; and
responsive to detecting the occurrence of the triggering event, at least one of: obtain the request from the first application, convert the at least one data object from the first application format to the platform specific format, or convert the at least one first modified data object from the platform specific format to the backend system format.

20. A non-transitory computer-readable storage medium of claim 16, wherein at least one of: obtaining the request from the first application, converting the at least one data object from the first application format to the platform specific format, or converting the at least one first modified data object from the platform specific format to the backend system format, is performed in accordance with a schedule maintained by the integration platform.
